(19) United States
(12) Patent Application Publication
(10) Pub. No.: US 2024/0413395 A1
(43) Pub. Date: Dec. 12, 2024

(54) Battery

(71) Applicant: ZHUHAI COSMX BATTERY CO., LTD., Zhuhai (CN)

(72) Inventors: Hai WANG, Zhuhai (CN); Jian ZHANG, Zhuhai (CN); Yingdi MU, Zhuhai (CN); Changan ZENG, Zhuhai (CN); Rude GUO, Zhuhai (CN); Suli LI, Zhuhai (CN); Junyi LI, Zhuhai (CN); Dayan QIAN, Zhuhai (CN)

(73) Assignee: ZHUHAI COSMX BATTERY CO., LTD., Zhuhai (CN)

(21) Appl. No.: 18/398,814

(22) Filed: Dec. 28, 2023

Related U.S. Application Data
(63) Continuation-in-part of application No. PCT/CN2022/140305, filed on Dec. 20, 2022.

(30) Foreign Application Priority Data
Dec. 20, 2021 (CN) 202111564992.7
Dec. 20, 2021 (CN) 202111566898.5
Dec. 20, 2021 (CN) 202111566903.2

(51) Int. Cl. H01M 10/0567; H01M 4/02; H01M 4/13; H01M 10/0525; H01M 10/0569; H01M 10/42; H01M 50/417; H01M 50/491

(52) U.S. Cl. CPC H01M 10/0567; H01M 4/13; H01M 10/0525; H01M 10/0569; H01M 10/4235; H01M 50/417; H01M 50/491; H01M 2004/021; H01M 2004/027; H01M 2004/028; H01M 2300/0042

(57) ABSTRACT

Disclosed is a battery. And the present disclosure pertains to the field of battery technologies. The battery includes a positive electrode plate, a negative electrode plate, a separator, and an electrolyte solution, where the electrolyte solution has a contact angle θ≥60°. In the present disclosure, the contact angle of the electrolyte solution is increased, so that the electrolyte solution of the battery achieves high wettability for the positive electrode plate, the negative electrode plate, and the separator, so as to significantly improve cycling performance and safety performance of the battery.

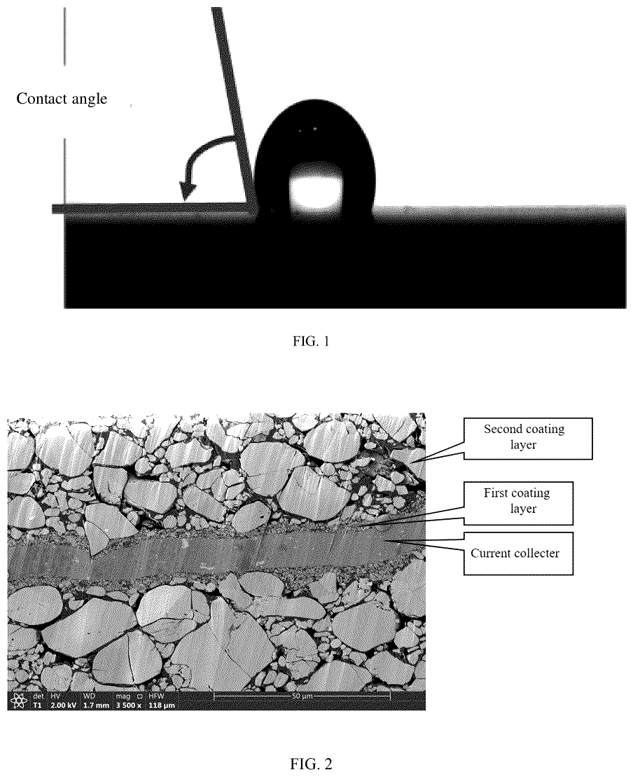

### CROSS-REFERENCE TO RELATED APPLICATIONS

The present disclosure is a continuation-in-part of International Application No. PCT/CN2022/140305, filed on Dec. 20, 2022, which claims priority to Chinese Patent Application No. 202111564992.7, filed on Dec. 20, 2021, Chinese Patent Application No. 202111566898.5, filed on Dec. 20, 2021, and Chinese Patent Application No. 202111566903.2, filed on Dec. 20, 2021. All of the aforementioned applications are hereby incorporated by reference in their entireties.

### TECHNICAL FIELD

The present disclosure pertains to the field of battery technologies, and in particular, to a battery.

### BACKGROUND

With advantages of high operating voltages, high specific energy density, long cycle life, low self-discharge rates, no memory effects, and low environmental pollution, lithium-ion batteries have been widely used in various consumer electronics markets, and are desirable power sources for future electric vehicles and various motor-driven tools.

Electrolyte solutions in current commercially available lithium-ion batteries are all in liquid form. A liquid electrolyte solution in a battery is dispersed in various gaps of a separator, an electrode plate, and a battery housing, and its main function is to transfer lithium ions.

It is found through study that when wettability of the electrolyte solution is poor, gaps in some places inside the battery are not fully filled with electrolyte solution, resulting in poor cycling performance of the battery, and even worse, lithium deposition occurs during charging of the battery, resulting in safety problems.

### SUMMARY

To improve disadvantages of conventional technologies, the present disclosure provides a battery. An electrolyte solution in the battery has high wettability for a positive electrode plate, a negative electrode plate, and a separator. The addition of the electrolyte solution may significantly improve cycling performance and safety performance of the battery.

Objectives of the present disclosure are achieved by using the following technical solutions.

A battery is provided, including a positive electrode plate, a negative electrode plate, a separator, and an electrolyte solution, where the electrolyte solution has a contact angle θ≥60°.

### <Electrolyte Solution>

In the present disclosure, “a contact angle of an electrolyte solution” refers to a contact angle of the electrolyte solution on a surface of a glass slide, and is an important parameter for measuring wettability performance of the electrolyte solution for a surface of a positive electrode plate, a surface of a negative electrode plate, and a surface of a separator. The contact angle is an angle between the electrolyte solution and the glass slide. The contact angle of the electrolyte solution on the surface of the glass slide is positively correlated with contact angles and wettability of the electrolyte solution on the surface of the positive electrode plate, the surface of the negative electrode plate, and the surface of the separator. That is, a greater contact angle of the electrolyte solution on the surface of the glass slide indicates higher wettability of the electrolyte solution for the positive electrode plate, the negative electrode plate, and the separator.

In one example, the contact angle θ of the electrolyte solution is greater than or equal to 60°. For example, the contact angle of the electrolyte solution is 60°, 70°, 80°, 90°, 100°, 110°, 120°, 130°, 140°, 150°, 160°, 170°, or 179°.

In one example, the electrolyte solution includes a lithium salt and a non-aqueous organic solvent.

In one example, the electrolyte solution further includes an additive, and the additive includes a nitrogen-containing compound.

In one example, a structural formula of the nitrogen-containing compound is shown in Formula (1):

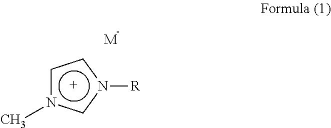

where R is a substituted or unsubstituted alkyl group, a substituted or unsubstituted ester group, a substituted or unsubstituted alkenyl group, or a substituted or unsubstituted aryl group; M⁻ is at least one of hexafluorophosphate, tetrafluoroborate, difluoro(oxalato)borate, bis(oxalate)borate, bis(fluorosulfonyl)imide, or bis(trifluoromethane)sulfonimide; and when a substituent is included, the substituent is an alkyl group, a halogen group or an alkoxy group.

In one example, R is —C₁₋₆Alkyl, —C₁₋₆Alkylene-COO—C₁₋₆Alkyl, —C₂₋₆Alkenyl, or —C₆₋₁₂Aryl. Preferably, R is —C₁₋₃Alkyl, —C₁₋₃Alkylene-COO—C₁₋₃Alkyl, —C₂₋₄Alkenyl, or —C₆₋₈Aryl.

In one example, the nitrogen-containing compound may be specifically at least one of the following two materials:

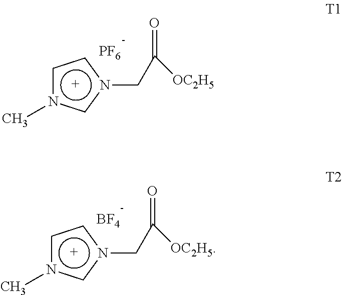

Cations in nitrogen-containing compound provided in the present disclosure can reduce surface tension of the electrolyte solution, increase the contact angle of the electrolyte solution, and significantly improve wettability of the electrolyte solution for the positive electrode plate, the negative electrode plate, and the separator. In addition, the cations can adsorb some active functional groups on a surface of a negative electrode active material. For example, a graphite surface contains some carboxyl functional groups. The cations in the nitrogen-containing compound can adsorb the carboxyl functional groups, thereby guiding the electrolyte solution to fully wet the negative electrode activity material. In addition, the nitrogen-containing compounds can further form an SEI film on a surface of a negative electrode. The SEI film has high strength and low impedance, and can improve a low-temperature discharge capability of the battery.

In one example, a mass percentage of the nitrogen-containing compound in a total mass of the electrolyte solution is B wt %, where B wt %≤2 wt %. That is, the mass percentage B wt % of the nitrogen-containing compound in the total mass of the electrolyte solution is less than or equal to 2 wt %, for example, 0.01 wt %≤B wt %≤1 wt %. For example, B wt % is 0.01 wt %, 0.02 wt %, 0.03 wt %, 0.04 wt %, 0.05 wt %, 0.1 wt %, 0.15 wt %, 0.2 wt %, 0.3 wt %, 0.4 wt %, 0.5 wt %, 0.6 wt %, 0.7 wt %, 0.8 wt %, 0.9 wt %, or 1 wt %.

In one example, the non-aqueous organic solvent is selected from a carbonate ester and/or a carboxylic ester.

The carbonate ester is selected from one or more of the following solvents: ethylene carbonate, propylene carbonate, dimethyl carbonate, diethyl carbonate, and ethyl methyl carbonate. The carboxylic ester is selected from one or more of the following solvents: propyl acetate, n-butyl acetate, isobutyl acetate, n-amyl acetate, isoamyl acetate, ethyl propionate, n-propyl propionate, methyl butyrate, and ethyl n-butyrate.

In one example, the non-aqueous organic solvent includes a linear carbonate ester having a quantity of carbon atoms less than or equal to 5 and/or a linear carboxylic ester having a quantity of carbon atoms less than or equal to 5.

Preferably, the linear carbonate ester having a quantity of carbon atoms less than or equal to 5 is selected from at least one of dimethyl carbonate, ethyl methyl carbonate, and diethyl carbonate.

Preferably, the linear carboxylic ester having a quantity of carbon atoms less than or equal to 5 is selected from at least one of ethyl propionate or propyl acetate.

Preferably, a mass percentage of a mass of the linear carbonate ester having a quantity of carbon atoms less than or equal to 5 and/or the linear carboxylic ester having a quantity of carbon atoms less than or equal to 5 in a total mass of the electrolyte solution is greater than or equal to 10 wt %, and preferably, ranges from 10 wt % to 70 wt %, for example, is 10 wt %, 20 wt %, 30 wt %, 40 wt %, 50 wt %, 60 wt %, or 70 wt %. The non-aqueous organic solvent provided in the present disclosure has a relatively small molecular chain. When a content of the non-aqueous organic solvent is greater than or equal to 10 wt %, wettability of the electrolyte solution for the positive electrode plate, the negative electrode plate, and the separator is further improved.

“A mass percentage of a mass of the linear carbonate ester having a quantity of carbon atoms less than or equal to 5 and/or the linear carboxylic ester having a quantity of carbon atoms less than or equal to 5 in a total mass of the electrolyte solution” means that when there is only “the linear carbonate ester having a quantity of carbon atoms less than or equal to 5” or “the linear carboxylic ester having a quantity of carbon atoms less than or equal to 5”, the mass percentage refers to a mass percentage of the component in the total mass of the electrolyte solution. When there are both “the linear carbonate ester having a quantity of carbon atoms less than or equal to 5” and “the linear carboxylic ester having a quantity of carbon atoms less than or equal to 5”, the mass percentage refers to a mass percentage of a sum of a mass of the two components in the total mass of the electrolyte solution.

In one example, the lithium salt is selected from one or more of lithium hexafluorophosphate, lithium difluorophosphate, lithium oxalyldifluoro borate, lithium bis(fluorosulfonyl)imide, lithium bis(trifluoromethanesulfonyl)imide, lithium difluorobis(oxalato)phosphate, lithium tetrafluoroborate, lithium bisoxalate borate, lithium hexafluoroantimonate, lithium hexafluoroarsenate, lithium bis(pentafluoroethanesulfonyl)imide, lithium tris(trifluoromethanesulfonyl)methyl, or lithium bis(trifluoromethanesulphonyl)imide.

In one example, a concentration of the lithium salt is less than or equal to 2 mol/L, for example, is 0.5 mol/L, 0.6 mol/L, 0.7 mol/L, 0.8 mol/L, 0.9 mol/L, 1 mol/L, 1.1 mol/L L, 1.2 mol/L, 1.3 mol/L, 1.4 mol/L, 1.5 mol/L, 1.6 mol/L, 1.7 mol/L, 1.8 mol/L, 1.9 mol/L, or 2 mol/L. It is found by the inventors that when the concentration of the lithium salt is greater than 2 mol/L, the contact angle of the electrolyte solution become smaller, affecting wettability of the electrolyte solution.

### <Positive Electrode>

Conventional positive electrodes in the art may be used in the present disclosure. The electrolyte solution in the present disclosure can show high wettability for a conventional positive electrode.

In order to better cooperate with the electrolyte solution in the present disclosure to produce a synergistic effect, the present disclosure further provides a preferred positive electrode plate.

In one example, the positive electrode plate includes a positive electrode current collector and a positive electrode coating layer. The positive electrode coating layer includes a first coating layer and a second coating layer, where the first coating layer is applied onto a surface of the positive electrode current collector, and the second coating layer is applied onto a surface of the first coating layer. The first coating layer includes an inorganic filler, a first conductive agent and a first binder; and the second coating layer includes a positive electrode active material, a second conductive agent, and a second binder. A thickness of the first coating layer is L, a thickness of the second coating layer is M, and L/M≤0.3.

It is found by the inventors of the present disclosure found that when L/M of the battery is less than or equal to 0.3 and the contact angle θ of the electrolyte solution is greater than or equal to 60°, wettability of the electrolyte solution for the positive electrode plate is very high, and the electrolyte solution has high fluidity and can well fill gaps inside the battery.

In one example, the thickness L of the first coating layer (thickness obtained after rolling) ranges from 2 μm to 10 μm, and for example, is 2 μm, 3 μm, 4 μm, 5 μm, 6 μm, 7 μm, 8 μm, 9 μm, or 10 μm.

In one example, the thickness M of the second coating layer (thickness obtained after rolling) ranges from 30 μm to 80 μm, and for example, is 30 μm, 35 μm, 40 μm, 45 μm, 50 μm, 55 μm, 60 μm, 65 μm, 70 μm, 75 μm, or 80 μm.

In one example, a content of the first binder in the first coating layer is greater than a content of the second binder in the second coating layer.

In one example, the positive electrode current collector is bonded to a part of the first binder, and a part of the positive electrode active material is bonded to another part of the first binder.

In one example, a median particle size Dv50 of the inorganic filler is less than a median particle size Dv50 of the positive electrode active material.

In one example, a median particle size Dv50 of the inorganic filler ranges from 0.05 μm to 8 μm, for example, is 0.05 μm, 0.1 μm, 0.5 μm, 1 μm, 2 μm, 3 μm, 4 μm, 5 μm, 6 μm, 7 μm, or 8 μm.

In one example, a median particle size Dv50 of the positive electrode active material ranges from 10 μm to 20 μm, for example, is 10 μm, 11 μm, 12 μm, 13 μm, 14 μm, 15 μm, 16 μm, 17 μm, 18 μm, 19 μm, or 20 μm.

It is found by the inventors of the present disclosure that when the median particle size Dv50 of the positive electrode active material is within a specific range, it helps form larger cavities, which can improve a wetting effect of the electrolyte solution for the first coating layer and the second coating layer.

In one example, mass percentages of components in the first coating layer are as follows: 40 wt % to 93 wt % of the inorganic filler, 2 wt % to 15 wt % of the first conductive agent, and 5 wt % to 58 wt % of the first binder. When the first binder is within this range, the first binder can have a good bonding effect with the positive electrode current collector. If a content of the first binder is too high, an energy density and performance of a battery cell decrease. If a content of the first binder is in this range and the inorganic filler has a median particle size Dv50 ranging from 0.05 μm to 8 μm, the first coating layer with a strong adhesion and a high density can be formed.

For example, a mass percentage of the inorganic filler in a total mass of components in the first coating layer is 40 wt %, 45 wt %, 48 wt %, 50 wt %, 55 wt %, 58 wt %, 60 wt %, 62 wt %, 65 wt %, 68 wt %, 70 wt %, 72 wt %, 75 wt %, 78 wt %, 80 wt %, 82 wt %, 85 wt %, 88 wt %, 90 wt %, 92 wt %, or 93 wt %.

For example, a mass percentage of the first conductive agent in a total mass of components in the first coating layer is 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or 15 wt %.

For example, a mass percentage of the first binder in a total mass of components in the first coating layer is 5 wt %, 6 wt %, 7 wt %, 8 wt %, 9 wt %, 10 wt %, 11 wt %, 12 wt %, 13 wt %, 14 wt %, 15 wt %, 18 wt %, 20 wt %, 22 wt %, 25 wt %, 28 wt %, 30 wt %, 33 wt %, 35 wt %, 38 wt %, 40 wt %, 45 wt %, 48 wt %, 50 wt %, 55 wt %, or 58 wt %.

Preferably, the mass percentages of components in the first coating layer are as follows: 60 wt % to 91 wt % of the inorganic filler, 2 wt % to 10 wt % of the first conductive agent, and 7 wt % to 30 wt % of the first binder.

Further, preferably, the mass percentages of components in the first coating layer are as follows: 60 wt % to 91 wt % of the inorganic filler, 3 wt % to 10 wt % of the first conductive agent, and 8 wt % to 30 wt % of the first binder.

In one example, mass percentages of components in the second coating layer are as follows: 93 wt % to 99 wt % of the positive electrode active material, 0.5 wt % to 5 wt % of the second conductive agent, and 0.5 wt % to 2 wt % of the second binder. Selecting the second binder with a content in this range can provide a better bonding effect while maintaining a high energy density.

For example, a mass percentage of the positive electrode active material in a total mass of components in the second coating layer is 93 wt %, 94 wt %, 95 wt %, 96 wt %, 97 wt %, 98 wt %, or 99 wt %.

For example, a mass percentage of the second conductive agent in a total mass of components in the second coating layer is 0.5 wt %, 1 wt %, 1.5 wt %, 1.8 wt %, 2 wt %, 2.2 wt %, 2.5 wt %, 2.8 wt %, 3 wt %, 3.5 wt %, 4 wt %, 4.5 wt %, or 5 wt %.

For example, a mass percentage of the second binder in a total mass of components in the second coating layer is 0.5 wt %, 0.8 wt %, 1 wt %, 1.2 wt %, 1.5 wt %, 1.8 wt %, or 2 wt %.

Preferably, the mass percentages of components in the second coating layer are as follows: 95 wt % to 98 wt % of the positive electrode active material, 1 wt % to 3 wt % of the second conductive agent, and 1 wt % to 2 wt % of the second binder.

In one example, the first conductive agent and the second conductive agent are the same or different, and are independently selected from at least one of conductive carbon black, carbon nanotubes, or graphene.

In one example, the first binder and the second binder are the same or different, and are independently selected from at least one of polyvinylidene fluoride or modified polyvinylidene fluoride.

Both the polyvinylidene fluoride and the modified polyvinylidene fluoride are commercially available products.

In one example, crystallinity of the first binder is less than 40%, because low crystallinity has a better bonding effect than high crystallinity.

In one example, crystallinity of the second binder is less than 40%, because low crystallinity has a better bonding effect than high crystallinity.

In one example, the modified polyvinylidene fluoride is acrylate-modified polyvinylidene fluoride. The acrylate group contains a carboxyl group, which can form a chemical bond with the positive electrode current collector (such as an aluminum foil) to achieve strong bonding with the positive electrode current collector.

In one example, a molecular weight of the polyvinylidene fluoride or the modified polyvinylidene fluoride ranges from 1 million Da to 1.5 million Da, and for example, is 1.1 million Da or 1.3 million Da. Selecting a binder with a larger molecular weight can enhance adhesion performance, while reducing a content of the binder and enhancing an energy density of the battery.

In one example, the inorganic filler is selected from a lithium-containing transition metal oxide, and specifically is selected from one or more of lithium cobalt oxide (LCO), nickel cobalt manganese ternary material (NCM), nickel cobalt aluminum ternary material (NCA), nickel cobalt manganese aluminum quaternary material (NCMA), lithium ferrous phosphate (LFP), lithium manganese phosphate (LMP), lithium vanadium phosphate (LVP), lithium manganate (LMO), and lithium-rich manganese-based material.

In one example, the inorganic filler is selected from a ceramic material, and specifically is selected from one or more of aluminum oxide, boehmite, magnesium oxide, and magnesium hydroxide.

In one example, the inorganic filler includes a mixture of at least one of the lithium-containing transition metal oxides and at least one of the ceramic materials.

In the present disclosure, the inorganic filler functions as a skeleton support.

In one example, the positive electrode active material is selected from one or more of lithium cobalt oxide (LCO), nickel cobalt manganese ternary material (NCM), nickel cobalt aluminum ternary material (NCA), nickel cobalt manganese aluminum quaternary material (NCMA), lithium ferrous phosphate (LFP), lithium manganese phosphate (LMP), lithium vanadium phosphate (LVP), and lithium manganate (LMO).

The positive electrode plate in the present disclosure is a double-layer coating.

In one example, the inorganic filler is lithium ferrous phosphate, and the positive electrode active material is lithium cobalt oxide. After a coating layer of the positive electrode plate is peeled off, detection is performed by using an EDS on a surface of a positive electrode coating remaining on the positive electrode current collector, to detect Co and O elements.

In one example, the positive electrode current collector is selected from an aluminum foil.

In one example, a thickness of the positive electrode current collector ranges from 8 μm to 15 μm, for example, is 8 μm, 9 μm, 10 μm, 11 μm, 12 μm, 13 μm, 14 μm, or 15 μm.

### <Negative Electrode>

Conventional negative electrode electrodes in the art may be used in the present disclosure. The electrolyte solution in the present disclosure can show high wettability for a conventional negative electrode.

In order to better cooperate with the electrolyte solution in the present disclosure to produce a synergistic effect, the present disclosure further provides a preferred negative electrode plate.

In one example, the negative electrode plate satisfies the following: a thickness of the negative electrode plate is less than 200 μm, and/or a single surface density of the negative electrode plate is less than or equal to 0.013 g/cm².

It is found through research by the inventors of the present disclosure that when the thickness of the negative electrode plate of the battery is less than 200 μm and/or the single surface density of the negative electrode plate is less than or equal to 0.013 g/cm², and when the contact angle θ of the electrolyte solution is greater than or equal to 60°, wettability of the electrolyte solution for the negative electrode plate is very high, and the electrolyte solution has high fluidity and can well fill gaps inside the battery.

In one example, the thickness of the negative electrode plate is less than 200 μm. For example, the thickness of the negative electrode plate is 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, or 190 μm.

In one example, the single surface density of the negative electrode plate is less than or equal to 0.013 g/cm². For example, the single surface density of the negative electrode plate is 0.005 g/cm², 0.006 g/cm², 0.007 g/cm², 0.008 g/cm², 0.009 g/cm², 0.010 g/cm², 0.011 g/cm², or 0.012 g/cm², and for example, is less than or equal to 0.010 g/cm², or less than or equal to 0.009 g/cm².

In one example, a mass percentage of the nitrogen-containing compound in a total mass of the electrolyte solution is B wt %, where a ratio of B to the thickness (unit: μm) of the negative electrode plate is greater than or equal to 0.0001. Preferably, the ratio of B to the thickness (unit: μm) of the negative electrode plate is greater than or equal to 0.0005. It is found through research in the present disclosure that negative electrode plates with different thicknesses require a specific amount of the nitrogen-containing compound to improve wettability of the electrolyte solution for them. When the ratio of B to the thickness (unit: μm) of the negative electrode plate is greater than or equal to 0.0001, an optimal relationship between the thickness of the negative electrode plate and the content of the nitrogen-containing compound in the electrolyte solution may be obtained.

In one example, a mass percentage of the nitrogen-containing compound in a total mass of the electrolyte solution is B wt %, where a ratio of B to the single surface density (unit: g/cm²) of the negative electrode plate is greater than or equal to 6. Preferably, the ratio of B to the single surface density (unit: g/cm²) of the negative electrode plate is greater than or equal to 10. It is found through research in the present disclosure that negative electrode plates with different single surface densities require a specific amount of the nitrogen-containing compound to improve wettability of the electrolyte solution for them. When the ratio of B to the single surface density (unit: g/cm²) of the negative electrode plate is greater than or equal to 6, an optimal relationship between the single surface density of the negative electrode plate and the content of the nitrogen-containing compound in the electrolyte solution may be obtained.

In one example, the negative electrode plate includes a negative electrode current collector and a negative electrode active material layer coated on a surface of either side or both sides of the negative electrode current collector, and the negative electrode active material layer includes a negative electrode active material, a third conductive agent, a third binder, and any auxiliary agent.

In one example, the negative electrode active material layer includes components with the following mass percentages:

90 wt % to 99.6 wt % of the negative electrode active material, 0.2 wt % to 5 wt % of the third conductive agent, and 0.2 wt % to 5 wt % of the third binder.

For example, a mass percentage of the negative electrode active material in a total mass of the components in the negative electrode active material layer is 90 wt %, 91 wt %, 92 wt %, 93 wt %, 94 wt %, 95 wt %, 96 wt %, 97 wt %, 98 wt %, 99 wt %, or 99.6 wt %.

For example, a mass percentage of the third conductive agent in a total mass of the components in the negative active electrode material layer is 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, or 5 wt %.

For example, a mass percentage of the third binder in a total mass of the components in the negative electrode active material layer is 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, or 5 wt %.

In one example, the negative electrode active material is selected from at least one of artificial graphite, natural graphite, hard carbon, soft carbon, silicon oxygen, or a silicon-carbon negative electrode material.

In one example, the third conductive agent is selected from one or more of conductive carbon black, ketjen black, conductive fiber, conductive polymer, acetylene black, carbon nanotubes, graphene, flake graphite, conductive oxide, and metal particles.

In one example, the third binder is selected from at least one of polyvinylidene fluoride or its copolymerized derivative, polytetrafluoroethylene or its copolymerized derivative, polyacrylic acid or its copolymerized derivative, polyvinyl alcohol or its copolymerized derivative, styrene-butadiene rubber or its copolymer derivative, polyimide or its copolymer derivative, polyethyleneimine or its copolymer derivative, polyacrylic acid ester or its copolymer derivative, or sodium carboxymethyl cellulose or its copolymer derivative.

In one example, a porosity of the negative electrode plate ranges from 20% to 55%, and for example, is 20%, 25%, 30%, 35%, 40%, 45%, 50%, or 55%.

It is found by the inventors of the present disclosure that in the present disclosure, when the porosity of the negative electrode plate is within a specific range, it facilitates wettability of the electrolyte solution.

In one example, a press density of the negative electrode plate ranges from 1.2 g/cm³ to 1.9 g/cm³, and for example, is 1.2 g/cm³, 1.3 g/cm³, 1.4 g/cm³, 1.5 g/cm³, 1.6 g/cm³, 1.7 g/cm³, 1.8 g/cm³, or 1.9 g/cm³.

It is found by the inventors of the present disclosure that in the present disclosure, when the press density of the negative electrode plate is within a specific range, it facilitates wettability of the electrolyte solution.

In one example, an OI value of the negative electrode plate ranges from 4.3 to 34, and for example, is 4.3, 5, 6, 7, 8, 9, 10, 15, 20, 25, 30, or 34.

The OI value of the negative electrode plate may be obtained by a X-ray powder diffractometer (XRD), and obtained according to an equation OI value=C₀₀₄/C₁₁₀, where C₀₀₄ represents characteristic diffraction peak area of (004) crystal plane, and C₁₁₀ represents characteristic diffraction peak area of (110) crystal plane.

It is found by the inventors of the present disclosure that in the present disclosure, when the OI value of the negative electrode plate is within a specific range, it facilitates wettability of the electrolyte solution.

In one example, a unit thickness capacity of the negative electrode plate ranges from 26.9 mAh/μm to 123 mAh/μm, and for example, is 26.9 mAh/μm, 27 mAh/μm, 30 mAh/μm, 40 mAh/μm, 50 mAh/μm, 60 mAh/μm, 70 mAh/μm, 80 mAh/μm, 90 mAh/μm, 100 mAh/μm, 110 mAh/μm, 120 mAh/μm, or 123 mAh/μm.

It is found by the inventors of the present disclosure that in the present disclosure, when the unit thickness capacity of the negative electrode plate is within a specific range, it facilitates wettability of the electrolyte solution.

In one example, a D/d range of the negative electrode plate is 1.04≤D/d≤1.1, where D is a thickness of the negative electrode plate obtained after rolling and left for 48 hours, and d is a thickness of the negative electrode plate obtained after rolling.

In one example, the thickness of the negative electrode plate and a thickness of the positive electrode plate satisfy the following relationship: a ratio of the thickness of the positive electrode plate to the thickness of the negative electrode plate is (0.93-1.48):1, for example, is 0.93:1, 0.94:1, 0.95:1, 0.96:1, 0.97:1, 0.98:1, 0.99:1, 1:1, 1.1:1, 1.2:1, 1.3:1, 1.4:1, or 1.48:1.

### <Separator>

Conventional separators in the art may be used in the present disclosure. The electrolyte solution in the present disclosure can show high wettability for a conventional separator.

In order to better cooperate with the electrolyte solution in the present disclosure to produce a synergistic effect, the present disclosure further provides a preferred separator.

In one example, the separator includes a porous polyolefin separator base material, and a porosity of the porous polyolefin separator base material is greater than or equal to 35%.

It is found by the inventors of the present disclosure that when the porosity of the porous polyolefin separator base material of the battery is greater than or equal to 35% and the contact angle θ of the electrolyte solution is greater than or equal to 60°, wettability of the electrolyte solution for the separator is very high, and the electrolyte solution has high fluidity and can well fill gaps inside the battery.

In one example, the porosity of the porous polyolefin separator base material is greater than or equal to 35%. For example, the porosity of the separator base material is 35%, 36%, 37%, 38%, 39%, 40%, 41%, 42%, 43%, 44%, 45%, 46%, 47%, 48%, 49%, or 50%, for example, is greater than or equal to 40%, and for another example, is greater than or equal to 50%.

In one example, the porous polyolefin separator base material may be at least one of a porous polyethylene separator base material, a porous polypropylene separator base material, or a porous polyethylene-polypropylene composite separator base material.

In one example, the separator further includes a third coating layer, and the third coating layer is provided on at least one functional surface of the porous polyolefin separator base material. That is, the separator includes the porous polyolefin separator base material and the third coating layer provided on at least one functional surface of the porous polyolefin separator base material.

It can be understood that the separator in the present disclosure may be obtained by providing the third coating layer on any functional surface of the porous polyolefin separator base material, or by providing the third coating layer on both functional surfaces of the porous polyolefin separator base material. Certainly, the porous polyolefin separator base material may alternatively be used as the separator.

The third coating layer includes at least one of inorganic particles or a polymer.

The inorganic particles in the present disclosure may be selected from inorganic particles commonly used in the art, for example, selected from at least one of aluminum oxide, silicon dioxide, boehmite, zinc oxide, magnesium oxide, zirconium dioxide, titanium oxide, barium oxide, calcium oxide, aluminum nitride, titanium nitride, silicon nitride, boron nitride, aluminum hydroxide, magnesium hydroxide, or barium sulfate.

The polymer in the present disclosure may be selected from polymers commonly used in the art, for example, selected from selected from at least one of polyvinylidene fluoride, copolymer of vinylidene fluoride-hexafluoropropylene, sodium carboxymethyl cellulose, polyacrylic acid ester, polyacrylonitrile, polyvinyl alcohol, styrene-butadiene rubber, polyurethane, copolymer of ethylene-acrylic acid, polymethyl methacrylate, polyimide, aramid, polystyrene, or polyester.

In the present disclosure, if the third coating layer includes only the inorganic particles, it is referred to as an inorganic coating layer; if the third coating layer includes only the polymer, it is referred to as an organic coating layer; or if the third coating layer includes both the inorganic particles and the polymer, it is referred to as a composite coating layer. The separator in the present disclosure may be obtained by providing at least one of the inorganic coating layer, the organic coating layer, or the composite coating layer on any functional surface of the porous polyolefin separator base material, or by providing at least one of the inorganic coating layer, the organic coating layer, or the composite coating layer on both functional surfaces of the porous polyolefin separator base material.

When at least two of the inorganic coating layer, the organic coating layer, and the composite coating layer are provided on a specific functional surface of the porous polyolefin separator base material, the at least two of inorganic coating layer, the organic coating layer, and the composite coating layer may be stacked, or the at least two of the inorganic coating layer, the organic coating layer, and the composite coating layer may be provided side by side on the functional surface of the porous polyolefin separator base material. Moreover, in the present disclosure, a stacking order is not particularly limited, and a side-by-side order is not particularly limited.

In one example, the inorganic coating layer is provided on a specific functional surface of the porous polyolefin separator base material, and the organic coating layer or the composite coating layer or both are provided on a functional surface, away from the porous polyolefin separator base material, of the inorganic coating layer.

In one example, a mass percentage of the nitrogen-containing compound in a total mass of the electrolyte solution is B wt %, where a ratio of B to a value of the porosity of the separator base material is greater than or equal to 0.02 and less than or equal to 10. Preferably, the ratio of B to the value of the porosity of the separator base material is greater than or equal to 0.05 and less than or equal to 10. It is found through research in the present disclosure that separators with different porosities require a specific amount of the nitrogen-containing compound to improve wettability of the electrolyte solution for them. When the ratio of B to the value of the porosity of the separator base material is greater than or equal to 0.02, an optimal relationship between the porosity of the separator base material and a content of the nitrogen-containing compound in the electrolyte solution is obtained.

It may be understood that the battery in the present disclosure further includes an outer packaging. In the present disclosure, the positive electrode plate, the separator, and the negative electrode plate are stacked to obtain a battery cell, or the positive electrode plate, the separator, and the negative electrode plate are stacked and then wound to obtain a battery cell. The battery cell is placed in the outer packaging, and the electrolyte solution is injected into the outer packaging, so that the battery in the present disclosure may be obtained. A specific structure of the outer packaging is not particularly specified, and may be selected from outer packaging in the art.

Beneficial effects of the present disclosure are as follows:
(1) In the present disclosure, the contact angle of the electrolyte solution is increased, and the ratio of the thickness of the first coating layer to the thickness of the second coating layer in the positive electrode plate is reduced, so that the electrolyte solution of the battery achieves high wettability for the positive electrode plate, so as to significantly improve cycling performance and safety performance of the battery. In addition, in order to increase the contact angle of the electrolyte solution, the nitrogen-containing compound is further used as an additive. Moreover, in order to optimize the electrolyte solution, adjusting a relationship between the content of the nitrogen-containing compound and the ratio of the thickness of the first coating layer to the thickness of the second coating layer in the positive electrode plate greatly improves wettability of the electrolyte solution for the positive electrode plate.
(2) The positive electrode plate in the present disclosure includes the positive electrode current collector and the positive electrode coating layer. The positive electrode coating layer includes a first coating layer and a second coating layer. The first coating layer is coated on a surface of the positive electrode current collector, and the second coating layer is coated on a surface of the first coating layer. In the present disclosure, a bonding force between the first coating layer and the positive electrode current collector is greater than a bonding force between the first coating layer and the second coating layer; and/or the bonding force between the first coating layer and the positive electrode current collector is greater than a bonding force between particles of the positive electrode active material of the second coating layer, and after the positive electrode coating layer of the positive electrode plate is peeled off, a total mass of the positive electrode coating layer remaining on the positive electrode current collector accounts for at least 10% of a total mass of the positive electrode coating layer on the positive electrode current collector before it is peeled off. The accordingly obtained battery has high safety performance, and a probability of a failure due to a battery fire is greatly reduced in the event of mechanical abuse (pinprick or heavy impact).
(3) In the present disclosure, the contact angle of the electrolyte solution is increased, and the thickness of the negative electrode plate or the single surface density of the negative electrode plate or both are reduced, so that the electrolyte solution of the battery achieves high wettability for the negative electrode plate, so as to significantly improve cycling performance of the battery. In addition, in order to increase the contact angle of the electrolyte solution, the nitrogen-containing compound is further used as an additive. Moreover, in order to optimize the electrolyte solution, adjusting a relationship between the content of the nitrogen-containing compound and the thickness of the negative electrode plate, and/or a relationship between the content of the nitrogen-containing compound and the single surface density of the negative electrode plate greatly improves wettability of the electrolyte solution for the negative electrode plate.
(4) The nitrogen-containing compound in the present disclosure can be adsorbed on a surface of the negative electrode, to reduce side reactions of components of the electrolyte solution on the surface of the negative electrode, thereby reducing impedance performance of the battery and significantly improving low-temperature discharge performance of the battery.
(5) In the present disclosure, the contact angle of the electrolyte solution is increased, and the porosity of the porous polyolefin separator base material is improved, so that the electrolyte solution of the battery achieves high wettability for the separator, so as to significantly improve cycling performance and safety performance of the battery. In addition, in order to increase the contact angle of the electrolyte solution, the nitrogen-containing compound is further used as an additive. Moreover, in order to optimize the electrolyte solution, adjusting a relationship between the content of the nitrogen-containing compound and the porosity of the porous polyolefin separator base material greatly improves wettability of the electrolyte solution for the separator.

### DETAILED DESCRIPTION OF THE EMBODIMENTS

To make the objectives, technical solutions, and advantages of the present disclosure clearer, the following clearly describes the technical solutions in the examples of the present disclosure with reference to the examples of the present disclosure. Apparently, the described examples are some but not all of the examples of the present disclosure. All other examples obtained by a person of ordinary skill in the art based on the examples of the present disclosure without creative efforts fall within the protection scope of the present disclosure.

Introduction to a method for testing a contact angle of an electrolyte solution:

A contact angle test apparatus with model JC2000D1 was used. A test environment was as follows: at a temperature of 20° C. to 30° C. and with a humidity of less than or equal to RH of 70%. Test steps were as follows: placing a clean glass slide on the sample stage; using a sampler to extract 1 μL electrolyte solution sample, and dropping it onto the glass slide; and five seconds after the electrolyte solution sample is dropped onto the glass slide, capturing a picture by using a computer, to obtain a test result, and analyzing the value of the contact angle.

### Examples and Comparative Examples

Batteries in Examples 1-9 and Comparative Examples 1-3 were prepared through the following steps:

### (1) Preparation of a Positive Electrode Plate

Step 1: Preparation of a first coating slurry. 40 wt % of lithium ferrous phosphate (LFP) (Dv50=200 nm), 45 wt % of modified polyvinylidene fluoride (modified PVDF, with a molecular weight of 1 million Da), and 15 wt % of conductive carbon black were mixed, N-methylpyrrolidone (NMP) was added, and a slurry was obtained after stirring.
Step 2: Preparation of a second coating slurry. 97 wt % of lithium cobalt oxide (Dv50=15 μm), 1 wt % of conductive carbon black, 0.8 wt % of carbon nanotubes, and 1.2 wt % of PVDF (a molecular weight of 1 million Da) were mixed, NMP was added, and a slurry was obtained after stirring.
Step 3: The first coating slurry obtained in step 1 was applied onto a surface of a positive electrode current collector (an aluminum foil with a thickness of 10 μm) by using an extrusion coating process to form a first coating layer with a thickness of L μm, and the second coating slurry obtained in step 2 was applied onto a surface of the first coating layer to form a second coating layer with a thickness of M μm.

### (2) Preparation of a Negative Electrode Plate

Negative electrode active materials artificial graphite, sodium carboxymethyl cellulose (CMC-Na), styrene-butadiene rubber, conductive carbon black (SP), and single-walled carbon nanotubes (SWCNTs) were mixed at a mass ratio of 96:1.5:1.5:0.9:0.1, and were added with deionized water, and a negative active slurry was obtained under action of a vacuum blender. The negative active slurry was evenly applied onto two functional surfaces of a copper foil. The coated copper foil was dried at room temperature, and then transferred to an oven at 80° C. for drying for 10 hours, followed by cold pressing and slitting, to obtain a negative electrode plate. A surface density of the negative electrode plate was 0.07 g/cm², a thickness of the copper foil was 6 μm, and a press density of the negative electrode plate was 1.78 g/cm³.

### (3) Preparation of an Electrolyte Solution

In an argon-filled glovebox (H₂O<0.1 ppm, and O₂<0.1 ppm), non-aqueous organic solvents were evenly mixed at mass percentages to obtain a mixed solution, and then a fully dried lithium salt with a specific concentration was quickly added to the mixed solution to form a basic electrolyte solution. Nitrogen-containing compounds at different mass percentages were added to the basic electrolyte solution, to obtain an electrolyte solution (specific composition of the electrolyte solution are shown in Table 1, where PC is propylene carbonate, EC is ethylene carbonate, DMC is dimethyl carbonate, EP is ethyl propionate, and EMC is ethyl methyl carbonate, and DEC is diethyl carbonate).

### (4) Preparation of a Battery

The positive electrode plate obtained in step (1), the negative electrode plate obtained in step (2), and a separator (a porous polyethylene film with a thickness of 12 μm) were stacked in an order of the positive electrode plate, the separator, and the negative electrode plate, and then wound to obtain a battery cell. The battery cell was placed in an outer packaging aluminum foil, and the electrolyte solution obtained in step (3) was injected into the outer packaging, and the battery was obtained through processes of vacuum packaging, standing, formation, shaping, sorting, and the like. Specific preparation parameters are shown in Table 1.

TABLE 1
Composition and performance test results of batteries in the Examples 1-9 and
Comparative Examples 1-3

| | Thickness | Thickness | | Electrolyte | | | Contact |
|---|---|---|---|---|---|---|---|
| | μm (L) of | μm (M) of | | solution | Nitrogen-containing | | angle of |
| | the first | the second | | Content of | compound | | the |
| | coating | coating | | solvents and | | Content | electrolyte |
| Number | layer | layer | L/M | lithium salt | Type | B | solution |
| Comparative | 7 | 70 | 0.1 | EC/PC/butyl | T1 | 0.10% | 57° |
| Example 1 | | | | propionate = | | | |
| | | | | 15/15/70 LiPF₆ = | | | |
| | | | | 1M | | | |
| Comparative | 15 | 30 | 0.5 | EC/PC/butyl | T1 | 0.10% | 143° |
| Example 2 | | | | propionate/DMC = | | | |
| | | | | 15/15/50/20 | | | |
| | | | | LiPF₆ = 1M | | | |
| Comparative | 15 | 30 | 0.5 | EC/PC/butyl | / | / | 120° |
| Example 3 | | | | propionate/DMC = | | | |
| | | | | 15/15/50/20 | | | |
| | | | | LiPF₆ = 1M | | | |
| Example 1 | 7 | 70 | 0.1 | EC/PC/butyl | T1 | 0.10% | 143° |
| | | | | propionate/DMC = | | | |
| | | | | 15/15/50/20 | | | |
| | | | | LiPF₆ = 1M | | | |
| Example 2 | 10 | 60 | 0.17 | EC/PC/butyl | T1 | 0.10% | 143° |
| | | | | propionate/DMC = | | | |
| | | | | 15/15/50/20 | | | |
| | | | | LiPF₆ = 1M | | | |
| Example 3 | 7 | 50 | 0.14 | EC/PC/butyl | T1 | 0.10% | 143° |
| | | | | propionate/DMC = | | | |
| | | | | 15/15/50/20 | | | |
| | | | | LiPF₆ = 1M | | | |
| Example 4 | 8 | 60 | 0.13 | EC/PC/butyl | T1 | 0.10% | 160° |
| | | | | propionate/DMC = | | | |
| | | | | 15/15/40/30 | | | |
| | | | | LiPF₆ = 1M | | | |
| Example 5 | 8 | 60 | 0.13 | EC/PC/butyl | T1 | 0.10% | 150° |
| | | | | propionate/EP = | | | |
| | | | | 15/15/40/30 | | | |
| | | | | LiPF₆ = 1M | | | |
| Example 6 | 8 | 60 | 0.13 | EC/PC/butyl | T1 | 0.10% | 147° |
| | | | | propionate/EMC = | | | |
| | | | | 15/15/40/30 | | | |
| | | | | LiPF₆ = 1M | | | |
| Example 7 | 8 | 60 | 0.13 | EC/PC/butyl | T1 | 0.10% | 94° |
| | | | | propionate/DEC = | | | |
| | | | | 15/15/40/30 | | | |
| | | | | LiPF₆ = 1M | | | |
| Example 8 | 3 | 60 | 0.05 | EC/PC/butyl | T2 | 0.50% | 179° |
| | | | | propionate/DMC = | | | |
| | | | | 15/15/40/30 | | | |
| | | | | LiPF₆ = 1M | | | |
| Example 9 | 3 | 60 | 0.05 | EC/PC/butyl | T2 | 0.10% | 165° |
| | | | | propionate/DMC = | | | |
| | | | | 15/15/40/30 | | | |
| | | | | LiPF₆ = 1M | | | |

Batteries in Examples 10-22 and Comparative Examples 4-8 were prepared through the following steps:

### (1) Preparation of a Positive Electrode Plate

Positive electrode active materials lithium cobalt oxide (Li_{1.05}CoO₂), binder polyvinylidene fluoride (PVDF), SP (super P), and carbon nanotubes (CNTs) were mixed at a mass ratio of 96:2:1.5:0.5, and were added with N-methylpyrrolidone (NMP). The mixture was stirred under action of a vacuum blender until a mixture system became a uniform fluid positive electrode active slurry. The positive electrode active slurry was evenly applied onto both functional surfaces of an aluminum foil. The coated aluminum foil was dried, then wound, and cut, to obtain a required positive electrode plate. A thickness of the positive electrode plate was 98 μm, and a thickness of the aluminum foil was 10 μm.

### (2) Preparation of a Negative Electrode Plate

Negative electrode active materials artificial graphite (gram capacity=355 mAh/g), sodium carboxymethyl cellulose (CMC-Na), styrene-butadiene rubber, conductive carbon black (SP), and single-walled carbon nanotubes (SWCNTs) were mixed at a mass ratio of 96:1.5:1.5:0.9:0.1, and were added with deionized water, and a negative active slurry was obtained under action of a vacuum blender. The negative active slurry was evenly applied onto two functional surfaces of a copper foil. The coated copper foil was dried at room temperature, and then transferred to an oven at 80° C. for drying for 10 hours, followed by cold pressing and slitting, to obtain a negative electrode plate. A thickness of the negative electrode plate was shown in Table 2, where a thickness of the copper foil was 6 μm, a porosity of the negative electrode plate was 27%, an OI value of the negative electrode plate was 17.81, D/d was 1.06, and a press density of the negative electrode plate was 1.78 g/cm³.

### (3) Preparation of an Electrolyte Solution

In an argon-filled glovebox (H₂O<0.1 ppm, and O₂<0.1 ppm), non-aqueous organic solvents were evenly mixed at mass percentages to obtain a mixed solution, and then a fully dried lithium salt with a specific concentration was quickly added to the mixed solution to form a basic electrolyte solution. Nitrogen-containing compounds at different mass percentages were added to the basic electrolyte solution, to obtain an electrolyte solution (specific composition of the electrolyte solution are shown in Table 2, where PC is propylene carbonate, EC is ethylene carbonate, DMC is dimethyl carbonate, EP is ethyl propionate, and EMC is ethyl methyl carbonate, and DEC is diethyl carbonate).

### (4) Preparation of a Battery

The positive electrode plate obtained in step (1), the negative electrode plate obtained in step (2), and a separator (a porous polyethylene film with a thickness of 12 μm) were stacked in an order of the positive electrode plate, the separator, and the negative electrode plate, and then wound to obtain a battery cell. The battery cell was placed in an outer packaging aluminum foil, and the electrolyte solution obtained in step (3) was injected into the outer packaging, and the battery was obtained through processes of vacuum packaging, standing, formation, shaping, sorting, and the like. Specific preparation parameters are shown in Table 2.

TABLE 2
Composition and performance test results of batteries in the Examples 10-22 and
Comparative Examples 4-8

| | | | | | | Ratio B/A of |
|---|---|---|---|---|---|---|
| | | | | | | a content of |
| | | | | | | an additive |
| | Thickness | | | | | to the |
| | A (μm) of | Electrolyte | | | Contact | thickness of |
| | the negative | solution | Nitrogen-containing | | angle of the | the negative |
| | electrode | Content of solvents | compound | | electrolyte | electrode |
| Number | plate | and lithium salt | Type | Content B | solution | plate |
| Comparative | 100 | EC/PC/butyl | T1 | 0.10% | 57° | 0.001 |
| Example 4 | | propionate = | | | | |
| | | 15/15/70 LiPF₆ = | | | | |
| | | 1M | | | | |
| Comparative | 250 | EC/PC/butyl | T1 | 0.10% | 143° | 0.0004 |
| Example 5 | | propionate/DMC = | | | | |
| | | 15/15/50/20 LiPF₆ = | | | | |
| | | 1M | | | | |
| Comparative | 100 | EC/PC/butyl | T1 | 0.10% | 45° | 0.001 |
| Example 6 | | propionate/DMC = | | | | |
| | | 15/15/50/20 LiPF₆ = | | | | |
| | | 2.5M | | | | |
| Comparative | 110 | EC/PC/butyl | / | | 48° | 0 |
| Example 7 | | propionate = | | | | |
| | | 15/15/70 LiPF₆ = | | | | |
| | | 1M | | | | |
| Comparative | 110 | EC/PC/butyl | T1 | 0.05% | 53° | 0.000455 |
| Example 8 | | propionate = | | | | |
| | | 15/15/70 LiPF₆ = | | | | |
| | | 1M | | | | |
| Example 10 | 100 | EC/PC/butyl | T1 | 0.10% | 143° | 0.001 |
| | | propionate/DMC = | | | | |
| | | 15/15/50/20 LiPF₆ = | | | | |
| | | 1M | | | | |
| Example 11 | 150 | EC/PC/butyl | T1 | 0.10% | 143° | 0.00067 |
| | | propionate/DMC = | | | | |
| | | 15/15/50/20 LiPF₆ = | | | | |
| | | 1M | | | | |
| Example 12 | 90 | EC/PC/butyl | T1 | 0.10% | 143° | 0.0011 |
| | | propionate/DMC = | | | | |
| | | 15/15/50/20 LiPF₆ = | | | | |
| | | 1M | | | | |
| Example 13 | 100 | EC/PC/butyl | T1 | 0.10% | 160° | 0.001 |
| | | propionate/DMC = | | | | |
| | | 15/15/40/30 LiPF₆ = | | | | |
| | | 1M | | | | |
| Example 14 | 100 | EC/PC/butyl | T1 | 0.10% | 150° | 0.001 |
| | | propionate/EP = | | | | |
| | | 15/15/40/30 LiPF₆ = | | | | |
| | | 1M | | | | |
| Example 15 | 100 | EC/PC/butyl | T1 | 0.10% | 147° | 0.001 |
| | | propionate/EMC = | | | | |
| | | 15/15/40/30 LiPF₆ = | | | | |
| | | 1M | | | | |
| Example 16 | 100 | EC/PC/butyl | T1 | 0.10% | 94° | 0.001 |
| | | propionate/DEC = | | | | |
| | | 15/15/40/30 LiPF₆ = | | | | |
| | | 1M | | | | |
| Example 17 | 100 | EC/PC/butyl | T2 | 0.50% | 179° | 0.005 |
| | | propionate/DMC = | | | | |
| | | 15/15/40/30 LiPF₆ = | | | | |
| | | 1M | | | | |
| Example 18 | 100 | EC/PC/butyl | T2 | 0.10% | 165° | 0.001 |
| | | propionate/DMC = | | | | |
| | | 15/15/40/30 LiPF₆ = | | | | |
| | | 1M | | | | |
| Example 19 | 110 | EC/PC/butyl | / | | 120° | 0 |
| | | propionate/DMC = | | | | |
| | | 15/15/50/20 LiPF₆ = | | | | |
| | | 1M | | | | |
| Example 20 | 110 | EC/PC/butyl | T1 | 0.05% | 123° | 0.000455 |
| | | propionate/DMC = | | | | |
| | | 15/15/50/20 LiPF₆ = | | | | |
| | | 1M | | | | |
| Example 21 | 110 | EC/PC/butyl | T2 | 1% | 78° | 0.009 |
| | | propionate/DMC = | | | | |
| | | 15/15/50/20 LiPF₆ = | | | | |
| | | 1M | | | | |
| Example 22 | 110 | EC/PC/butyl | T1 | 0.10% | 143° | 0.0009 |
| | | propionate/DMC = | | | | |
| | | 15/15/50/20 LiPF₆ = | | | | |
| | | 1M | | | | |

Batteries in Examples 23-35 and Comparative Examples 9-13 were prepared through the following steps:

### (1) Preparation of a Positive Electrode Plate

Positive electrode active materials lithium cobalt oxide (Li_{1.05}CoO₂), binder polyvinylidene fluoride (PVDF), SP (super P), and carbon nanotubes (CNTs) were mixed at a mass ratio of 96:2:1.5:0.5, and were added with N-methylpyrrolidone (NMP). The mixture was stirred under action of a vacuum blender until a mixture system became a uniform fluid positive electrode active slurry. The positive electrode active slurry was evenly applied onto both functional surfaces of an aluminum foil. The coated aluminum foil was dried, then wound, and cut, to obtain a required positive electrode plate. A thickness of the positive electrode plate was 98 μm, and a thickness of the aluminum foil was 10 μm.

### (2) Preparation of a Negative Electrode Plate

Negative electrode active materials artificial graphite, sodium carboxymethyl cellulose (CMC-Na), styrene-butadiene rubber, conductive carbon black (SP), and single-walled carbon nanotubes (SWCNTs) were mixed at a mass ratio of 96:1.5:1.5:0.9:0.1, and were added with deionized water, and a negative active slurry was obtained under action of a vacuum blender. The negative active slurry was evenly applied onto two functional surfaces of a copper foil. The coated copper foil was dried at room temperature, and then transferred to an oven at 80° C. for drying for 10 hours, followed by cold pressing and slitting, to obtain a negative electrode plate. A single surface density of the negative electrode plate was shown in Table 3, where a thickness of the copper foil was 6 μm, a porosity of the negative electrode plate was 28.4%, an OI value of the negative electrode plate was 18.31, D/d was 1.06, and a press density of the negative electrode plate was 1.65 g/cm³.

### (3) Preparation of an Electrolyte Solution

In an argon-filled glovebox (H₂O<0.1 ppm, and O₂<0.1 ppm), non-aqueous organic solvents were evenly mixed at mass percentages to obtain a mixed solution, and then a fully dried lithium salt with a specific concentration was quickly added to the mixed solution to form a basic electrolyte solution. Nitrogen-containing compounds at different mass percentages were added to the basic electrolyte solution, to obtain an electrolyte solution (specific composition of the electrolyte solution are shown in Table 3, where PC is propylene carbonate, EC is ethylene carbonate, DMC is dimethyl carbonate, EP is ethyl propionate, and EMC is ethyl methyl carbonate, and DEC is diethyl carbonate).

### (4) Preparation of a Battery

The positive electrode plate obtained in step (1), the negative electrode plate obtained in step (2), and a separator (a porous polyethylene film with a thickness of 12 μm) were stacked in an order of the positive electrode plate, the separator, and the negative electrode plate, and then wound to obtain a battery cell. The battery cell was placed in an outer packaging aluminum foil, and the electrolyte solution obtained in step (3) was injected into the outer packaging, and the battery was obtained through processes of vacuum packaging, standing, formation, shaping, sorting, and the like. Specific preparation parameters are shown in Table 3.

TABLE 3
Composition and performance test results of batteries in the Examples 23-35 and
Comparative Examples 9-13

| | | | | | | Ratio of |
|---|---|---|---|---|---|---|
| | Single | | | | | a content |
| | surface | | | | | of the |
| | density of | | Nitrogen-containing | | Contact | additive |
| | the negative | Electrolyte solution | compound | | angle of the | to a |
| | electrode | Content of solvents | | Content | electrolyte | surface |
| Number | plate (g/cm²) | and lithium salt | Type | B | solution | density |
| Comparative | 0.007 | EC/PC/butyl | T1 | 0.10% | 57° | 14.29 |
| Example 9 | | propionate = | | | | |
| | | 15/15/70 LiPF₆ = | | | | |
| | | 1M | | | | |
| Comparative | 0.015 | EC/PC/butyl | T1 | 0.10% | 143° | 6.67 |
| Example 10 | | propionate/DMC = | | | | |
| | | 15/15/50/20 LiPF₆ = | | | | |
| | | 1M | | | | |
| Comparative | 0.007 | EC/PC/butyl | T1 | 0.10% | 45° | 14.29 |
| Example 11 | | propionate/DMC = | | | | |
| | | 15/15/50/20 LiPF₆ = | | | | |
| | | 2.5M | | | | |
| Comparative | 0.008 | EC/PC/butyl | / | | 48° | 0.00 |
| Example 12 | | propionate = | | | | |
| | | 15/15/70 LiPF₆ = | | | | |
| | | 1M | | | | |
| Comparative | 0.008 | EC/PC/butyl | T1 | 0.05% | 53° | 6.25 |
| Example 13 | | propionate = | | | | |
| | | 15/15/70 LiPF₆ = | | | | |
| | | 1M | | | | |
| Example 23 | 0.007 | EC/PC/butyl | T1 | 0.10% | 143° | 14.29 |
| | | propionate/DMC = | | | | |
| | | 15/15/50/20 LiPF₆ = | | | | |
| | | 1M | | | | |
| Example 24 | 0.010 | EC/PC/butyl | T1 | 0.10% | 143° | 10.00 |
| | | propionate/DMC = | | | | |
| | | 15/15/50/20 LiPF₆ = | | | | |
| | | 1M | | | | |
| Example 25 | 0.004 | EC/PC/butyl | T1 | 0.10% | 143° | 25.00 |
| | | propionate/DMC = | | | | |
| | | 15/15/50/20 LiPF₆ = | | | | |
| | | 1M | | | | |
| Example 26 | 0.007 | EC/PC/butyl | T1 | 0.10% | 160° | 14.29 |
| | | propionate/DMC = | | | | |
| | | 15/15/40/30 LiPF₆ = | | | | |
| | | 1M | | | | |
| Example 27 | 0.007 | EC/PC/butyl | T1 | 0.10% | 150° | 14.29 |
| | | propionate/EP = | | | | |
| | | 15/15/40/30 LiPF₆ = | | | | |
| | | 1M | | | | |
| Example 28 | 0.007 | EC/PC/butyl | T1 | 0.10% | 147° | 14.29 |
| | | propionate/EMC = | | | | |
| | | 15/15/40/30 LiPF₆ = | | | | |
| | | 1M | | | | |
| Example 29 | 0.007 | EC/PC/butyl | T1 | 0.10% | 94° | 14.29 |
| | | propionate/DEC = | | | | |
| | | 15/15/40/30 LiPF₆ = | | | | |
| | | 1M | | | | |
| Example 30 | 0.007 | EC/PC/butyl | T2 | 0.50% | 179° | 71.43 |
| | | propionate/DMC = | | | | |
| | | 15/15/40/30 LiPF₆ = | | | | |
| | | 1M | | | | |
| Example 31 | 0.007 | EC/PC/butyl | T2 | 0.10% | 165° | 14.29 |
| | | propionate/DMC = | | | | |
| | | 15/15/40/30 LiPF₆ = | | | | |
| | | 1M | | | | |
| Example 32 | 0.008 | EC/PC/butyl | / | | 120° | 0.00 |
| | | propionate/DMC = | | | | |
| | | 15/15/50/20 LiPF₆ = | | | | |
| | | 1M | | | | |
| Example 33 | 0.008 | EC/PC/butyl | T1 | 0.05% | 123° | 6.25 |
| | | propionate/DMC = | | | | |
| | | 15/15/50/20 LiPF₆ = | | | | |
| | | 1M | | | | |
| Example 34 | 0.008 | EC/PC/butyl | T2 | 1% | 78° | 125.00 |
| | | propionate/DMC = | | | | |
| | | 15/15/50/20 LiPF₆ = | | | | |
| | | 1M | | | | |
| Example 35 | 0.008 | EC/PC/butyl | T1 | 0.10% | 143° | 12.5 |
| | | propionate/DMC = | | | | |
| | | 15/15/50/20 LiPF₆ = | | | | |
| | | 1M | | | | |

Batteries in Examples 36-48 and Comparative Examples 14-18 were prepared through the following steps:

### (1) Preparation of a Positive Electrode Plate

Positive electrode active materials lithium cobalt oxide (Li_{1.05}CoO₂), binder polyvinylidene fluoride (PVDF), SP (super P), and carbon nanotubes (CNTs) were mixed at a mass ratio of 96:2:1.5:0.5, and were added with N-methylpyrrolidone (NMP). The mixture was stirred under action of a vacuum blender until a mixture system became a uniform fluid positive electrode active slurry. The positive electrode active slurry was evenly applied onto both functional surfaces of an aluminum foil. The coated aluminum foil was dried, then wound, and cut, to obtain a required positive electrode plate. A thickness of the positive electrode plate was 98 μm, and a thickness of the aluminum foil was 10 μm.

### (2) Preparation of a Negative Electrode Plate

Negative electrode active materials artificial graphite, sodium carboxymethyl cellulose (CMC-Na), styrene-butadiene rubber, conductive carbon black (SP), and single-walled carbon nanotubes (SWCNTs) were mixed at a mass ratio of 96:1.5:1.5:0.9:0.1, and were added with deionized water, and a negative active slurry was obtained under action of a vacuum blender. The negative active slurry was evenly applied onto two functional surfaces of a copper foil. The coated copper foil was dried at room temperature, and then transferred to an oven at 80° C. for drying for 10 hours, followed by cold pressing and slitting, to obtain a negative electrode plate. A surface density of the negative electrode plate was 0.07 g/cm², a thickness of the copper foil was 6 μm, and a press density of the negative electrode plate was 1.78 g/cm³.

### (3) Preparation of an Electrolyte Solution

In an argon-filled glovebox (H₂O<0.1 ppm, and O₂<0.1 ppm), non-aqueous organic solvents were evenly mixed at mass percentages to obtain a mixed solution, and then a fully dried lithium salt with a specific concentration was quickly added to the mixed solution to form a basic electrolyte solution. Nitrogen-containing compounds at different mass percentages were added to the basic electrolyte solution, to obtain an electrolyte solution (specific composition of the electrolyte solution are shown in Table 4, where PC is propylene carbonate, EC is ethylene carbonate, DMC is dimethyl carbonate, EP is ethyl propionate, and EMC is ethyl methyl carbonate, and DEC is diethyl carbonate).

### (4) Preparation of a Battery

The positive electrode plate obtained in step (1), the negative electrode plate obtained in step (2), and a separator (a porous polyethylene film with a thickness of 12 μm, where a porosity of the porous polyethylene film was shown in Table 4) were stacked in an order of the positive electrode plate, the separator, and the negative electrode plate, and then wound to obtain a battery cell. The battery cell was placed in an outer packaging aluminum foil, and the electrolyte solution obtained in step (3) was injected into the outer packaging, and the battery was obtained through processes of vacuum packaging, standing, formation, shaping, sorting, and the like. Specific preparation parameters are shown in Table 4.

TABLE 4
Composition and performance test results of batteries in the Examples 36-48 and
Comparative Examples 14-18

| | | | | | | Ratio of a |
|---|---|---|---|---|---|---|
| | | | | | | content of |
| | | | | | | an additive |
| | | | | | | to the |
| | | | | | Contact | porosity of |
| | | | | | angle of | the |
| | Porosity | Electrolyte solution | Nitrogen-containing | | the | separator |
| | of a | Content of solvents | compound | | electrolyte | base |
| Number | separator | and lithium salt | Type | Content B | solution | material |
| Comparative | 40% | EC/PC/butyl | T1 | 0.10% | 57° | 0.25 |
| Example 14 | | propionate = 15/15/70 | | | | |
| | | LiPF₆ = 1M | | | | |
| Comparative | 30% | EC/PC/butyl | T1 | 0.10% | 143° | 0.33 |
| Example 15 | | propionate/DMC = | | | | |
| | | 15/15/50/20 LiPF₆ = | | | | |
| | | 1M | | | | |
| Comparative | 40% | EC/PC/butyl | T1 | 0.10% | 45° | 0.25 |
| Example 16 | | propionate/DMC = | | | | |
| | | 15/15/50/20 LiPF₆ = | | | | |
| | | 2.5M | | | | |
| Comparative | 40% | EC/PC/butyl | / | | 48° | 0 |
| Example 17 | | propionate = 15/15/70 | | | | |
| | | LiPF₆ = 1M | | | | |
| Comparative | 40% | EC/PC/butyl | T1 | 0.05% | 53° | 0.125 |
| Example 18 | | propionate = 15/15/70 | | | | |
| | | LiPF₆ = 1M | | | | |
| Example 36 | 38% | EC/PC/butyl | T1 | 0.10% | 143° | 0.26 |
| | | propionate/DMC = | | | | |
| | | 15/15/50/20 LiPF₆ = | | | | |
| | | 1M | | | | |
| Example 37 | 45% | EC/PC/butyl | T1 | 0.10% | 143° | 0.22 |
| | | propionate/DMC = | | | | |
| | | 15/15/50/20 LiPF₆ = | | | | |
| | | 1M | | | | |
| Example 38 | 36% | EC/PC/butyl | T1 | 0.10% | 143° | 0.28 |
| | | propionate/DMC = | | | | |
| | | 15/15/50/20 LiPF₆ = | | | | |
| | | 1M | | | | |
| Example 39 | 40% | EC/PC/butyl | T1 | 0.10% | 160° | 0.25 |
| | | propionate/DMC = | | | | |
| | | 15/15/40/30 LiPF₆ = | | | | |
| | | 1M | | | | |
| Example 40 | 40% | EC/PC/butyl | T1 | 0.10% | 150° | 0.25 |
| | | propionate/EP = | | | | |
| | | 15/15/40/30 LiPF₆ = | | | | |
| | | 1M | | | | |
| Example 41 | 40% | EC/PC/butyl | T1 | 0.10% | 147° | 0.25 |
| | | propionate/EMC = | | | | |
| | | 15/15/40/30 LiPF₆ = | | | | |
| | | 1M | | | | |
| Example 42 | 40% | EC/PC/butyl | T1 | 0.10% | 94° | 0.25 |
| | | propionate/DEC = | | | | |
| | | 15/15/40/30 LiPF₆ = | | | | |
| | | 1M | | | | |
| Example 43 | 40% | EC/PC/butyl | T2 | 0.50% | 179° | 1.25 |
| | | propionate/DMC = | | | | |
| | | 15/15/40/30 LiPF₆ = | | | | |
| | | 1M | | | | |
| Example 44 | 40% | EC/PC/butyl | T2 | 0.10% | 165° | 0.25 |
| | | propionate/DMC = | | | | |
| | | 15/15/40/30 LiPF₆ = | | | | |
| | | 1M | | | | |
| Example 45 | 40% | EC/PC/butyl | / | | 120° | 0 |
| | | propionate/DMC = | | | | |
| | | 15/15/50/20 LiPF₆ = | | | | |
| | | 1M | | | | |
| Example 46 | 40% | EC/PC/butyl | T1 | 0.05% | 123° | 0.125 |
| | | propionate/DMC = | | | | |
| | | 15/15/50/20 LiPF₆ = | | | | |
| | | 1M | | | | |
| Example 47 | 40% | EC/PC/butyl | T2 | 1% | 78° | 2.5 |
| | | propionate/DMC = | | | | |
| | | 15/15/50/20 LiPF₆ = | | | | |
| | | 1M | | | | |
| Example 48 | 40% | EC/PC/butyl | T1 | 0.10% | 143° | 0.25 |
| | | propionate/DMC = | | | | |
| | | 15/15/50/20 LiPF₆ = | | | | |
| | | 1M | | | | |

### Example 49

A batter was prepared through the following steps:

### (1) Preparation of a Positive Electrode Plate

Positive electrode active materials lithium cobalt oxide (Li_{1.05}CoO₂), binder polyvinylidene fluoride (PVDF), SP (super P), and carbon nanotubes (CNTs) were mixed at a mass ratio of 96:2:1.5:0.5, and were added with N-methylpyrrolidone (NMP). The mixture was stirred under action of a vacuum blender until a mixture system became a uniform fluid positive electrode active slurry. The positive electrode active slurry was evenly applied onto both functional surfaces of an aluminum foil. The coated aluminum foil was dried, then wound, and cut, to obtain a required positive electrode plate. A thickness of the positive electrode plate was 98 μm, and a thickness of the aluminum foil was 10 μm.

### (2) Preparation of a Negative Electrode Plate

Negative electrode active materials artificial graphite (gram capacity=355 mAh/g), sodium carboxymethyl cellulose (CMC-Na), styrene-butadiene rubber, conductive carbon black (SP), and single-walled carbon nanotubes (SWCNTs) were mixed at a mass ratio of 96:1.5:1.5:0.9:0.1, and were added with deionized water, and a negative active slurry was obtained under action of a vacuum blender. The negative active slurry was evenly applied onto two functional surfaces of a copper foil. The coated copper foil was dried at room temperature, and then transferred to an oven at 80° C. for drying for 10 hours, followed by cold pressing and slitting, to obtain a negative electrode plate. A thickness of the negative electrode plate was 100 μm, where a thickness of the copper foil was 6 μm, a porosity of the negative electrode plate was 27%, an OI value of the negative electrode plate was 17.81, D/d was 1.06, a press density of the negative electrode plate was 1.78 g/cm³, and a single surface density of the negative electrode plate was 0.007 g/cm².

### (3) Preparation of an Electrolyte Solution

In an argon-filled glovebox (H₂O<0.1 ppm, and O₂<0.1 ppm), EC, PC, butyl propionate, and DMC were evenly mixed at a mass ratio of 15:15:50:20 to obtain a mixed solution, and then fully dried IM LiPF₆ was added to the mixed solution to form a basic electrolyte solution. The 0.1% T1 was added to the basic electrolyte solution, to obtain an electrolyte solution, where a contact angle of the electrolyte solution was 143°.

### (4) Preparation of a Battery

The positive electrode plate obtained in step (1), the negative electrode plate obtained in step (2), and a separator (a porous polyethylene film with a thickness of 12 μm) were stacked in an order of the positive electrode plate, the separator, and the negative electrode plate, and then wound to obtain a battery cell. The battery cell was placed in an outer packaging aluminum foil, and the electrolyte solution obtained in step (3) was injected into the outer packaging, and the battery was obtained through processes of vacuum packaging, standing, formation, shaping, sorting, and the like.

The following tests were performed separately on batteries obtained in the foregoing Examples and Comparative Examples, and test results were shown in Table 5.

### (1) Cycling Performance Test

Batteries obtained in the Examples and Comparative Examples were charged and discharged for 100 cycles within a range of 3.0 V to 4.4 V at a rate of 1 C at 25° C. A discharge capacity of the first cycle and a discharge capacity of the 100^{th} cycle were tested. The capacity of the 100^{th} cycle was divided by the capacity of the first cycle to obtain cycle capacity retention.

### (2) Security Test

After the batteries obtained in the Examples and Comparative Examples were cycled, the battery was charged to 4.4 V under a constant current and constant voltage at a rate of 1 C, where a cut-off current was 0.05 C. Then, the battery was stored at 130° C. for 30 minutes. Whether the battery catches fire or explodes was observed.

### (3) Low-Temperature Discharge Performance Test

The batteries obtained in the Examples and Comparative Examples were charged and discharged five times at room temperature at a rate of 1 C, and then charged to a state of 4.45 V at a rate of 1 C, and a 1 C capacity Q₀ was recorded. After the fully charged battery is placed at −20° C. for four hours, it was discharged to 3 V at a rate of 0.2 C, and a discharge capacity Q₃ was recorded. A discharge capacity retention rate at −20° C. can be calculated.

A low-temperature discharge capacity retention rate was calculated as follows:

$$Low - temperature discharge capacity retention rate ( \% ) = \frac{{Q}_{3}}{{Q}_{0}} \times 100$$

TABLE 5
Performance test results of batteries in the Examples and Comparative Examples

| | Capacity retention ratio after | | Discharge capacity |
|---|---|---|---|
| Number | 100 cycles at 25° C. | Safety test | retention rate at −20° C. |
| Comparative | 61.26% | On fire | 42.46% |
| Example 1 | | | |
| Comparative | 62.13% | On fire | 43.15% |
| Example 2 | | | |
| Comparative | 60.65% | On fire | 21.81% |
| Example 3 | | | |
| Example 1 | 70.16% | Passed | 61.38% |
| Example 2 | 70.52% | Passed | 61.39% |
| Example 3 | 71.54% | Passed | 61.09% |
| Example 4 | 75.38% | Passed | 62.49% |
| Example 5 | 70.11% | Passed | 62.17% |
| Example 6 | 72.51% | Passed | 61.86% |
| Example 7 | 70.19% | Passed | 62.30% |
| Example 8 | 70.02% | Passed | 62.66% |
| Example 9 | 73.02% | Passed | 63.25% |
| Comparative | 52.46% | On fire | — |
| Example 4 | | | |
| Comparative | 43.55% | On fire | — |
| Example 5 | | | |
| Comparative | 51.57% | On fire | — |
| Example 6 | | | |
| Comparative | 52.46% | On fire | 10.9% |
| Example 7 | | | |
| Comparative | 47.51% | On fire | 25.7% |
| Example 8 | | | |
| Example 10 | 81.18% | Passed | — |
| Example 11 | 81.79% | Passed | — |
| Example 12 | 82.09% | Passed | — |
| Example 13 | 82.27% | Passed | — |
| Example 14 | 81.96% | Passed | — |
| Example 15 | 82.50% | Passed | — |
| Example 16 | 81.16% | Passed | — |
| Example 17 | 81.02% | Passed | — |
| Example 18 | 82.00% | Passed | — |
| Example 19 | 71.55% | Passed | 25.7% |
| Example 20 | 81.71% | Passed | 51.2% |
| Example 21 | 79.18% | Passed | 49.2% |
| Example 22 | 85.79% | Passed | 51.3% |
| Comparative | 55.40% | On fire | — |
| Example 9 | | | |
| Comparative | 46.93% | On fire | — |
| Example 10 | | | |
| Comparative | 53.40% | On fire | — |
| Example 11 | | | |
| Comparative | 53.06% | On fire | 11.4% |
| Example 12 | | | |
| Comparative | 49.10% | On fire | 24.9% |
| Example 13 | | | |
| Example 23 | 82.11% | Passed | — |
| Example 24 | 82.37% | Passed | — |
| Example 25 | 80.53% | Passed | — |
| Example 26 | 81.10% | Passed | — |
| Example 27 | 80.50% | Passed | — |
| Example 28 | 80.63% | Passed | — |
| Example 29 | 83.41% | Passed | — |
| Example 30 | 80.82% | Passed | — |
| Example 31 | 81.37% | Passed | — |
| Example 32 | 73.61% | Passed | 24.3% |
| Example 33 | 82.26% | Passed | 53.7% |
| Example 34 | 80.91% | Passed | 50.3% |
| Example 35 | 84.52% | Passed | 52.0% |
| Comparative | 51.59% | On fire | — |
| Example 14 | | | |
| Comparative | 41.47% | On fire | — |
| Example 15 | | | |
| Comparative | 50.88% | On fire | — |
| Example 16 | | | |
| Comparative | 53.01% | On fire | 18.1% |
| Example 17 | | | |
| Comparative | 44.41% | On fire | 31.6% |
| Example 18 | | | |
| Example 36 | 82.48% | Passed | — |
| Example 37 | 82.19% | Passed | — |
| Example 38 | 83.81% | Passed | — |
| Example 39 | 83.46% | Passed | — |
| Example 40 | 82.01% | Passed | — |
| Example 41 | 83.59% | Passed | — |
| Example 42 | 82.11% | Passed | — |
| Example 43 | 82.05% | Passed | — |
| Example 44 | 83.67% | Passed | — |
| Example 45 | 70.74% | Passed | 21.4% |
| Example 46 | 72.78% | Passed | 36.7% |
| Example 47 | 82.00% | Passed | 50.2% |
| Example 48 | 81.46% | Passed | 47.3% |
| Example 49 | 85.32% | Passed | — |

As can be seen from Table 5:
(1) When the contact angle of the electrolyte solution is less than 600 or L/M>0.3, cycling performance and safety performance of the battery drop sharply. Further, the addition of the nitrogen-containing compound can significantly improve wettability performance of the electrolyte solution for the positive electrode plate, thereby improving cycling performance of the battery and meanwhile improving low-temperature discharge performance of the battery.
(2) When the contact angle of the electrolyte solution is less than 600 or the thickness of the negative electrode plate is greater than or equal to 200 μm, cycling performance and safety performance of the battery drop sharply. Further, the addition of the nitrogen-containing compound can significantly improve wettability performance of the electrolyte solution for the negative electrode plate, thereby improving cycling performance of the battery and meanwhile improving low-temperature discharge performance of the battery.
(3) When the contact angle of the electrolyte solution is less than 60° or the single surface density of the negative electrode plate is greater than or equal to 0.013 g/cm², cycling performance and safety performance of the battery drop sharply. Further, the addition of the nitrogen-containing compound can significantly improve wettability performance of the electrolyte solution for the negative electrode plate, thereby improving cycling performance of the battery and meanwhile improving low-temperature discharge performance of the battery.
(4) When the contact angle of the electrolyte solution is less than 60° or the porosity of the porous polyolefin separator base material is less than 35%, cycling performance and safety performance of the battery drop sharply. Further, the addition of the nitrogen-containing compound can significantly improve wettability performance of the electrolyte solution for the separator, thereby improving cycling performance of the battery and meanwhile improving low-temperature discharge performance of the battery.

The implementations of the present disclosure are described above. However, the present disclosure is not limited to the foregoing implementations. Any modifications, equivalent replacements, improvements, and the like within the spirit and principle of the present disclosure shall fall within the scope of protection of the present disclosure.

What is claimed is:

1. A battery, comprising a positive electrode plate, a negative electrode plate, a separator, and an electrolyte solution, wherein the electrolyte solution has a contact angle θ≥60°.

2. The battery according to claim 1, wherein the electrolyte solution comprises a lithium salt and a non-aqueous organic solvent.

3. The battery according to claim 1, wherein the electrolyte solution further comprises an additive, and the additive comprises a nitrogen-containing compound; and
a structural formula of the nitrogen-containing compound is shown in Formula (1): 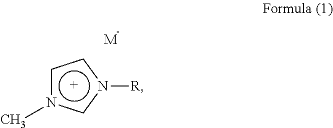
wherein R is a substituted or unsubstituted alkyl group, a substituted or unsubstituted ester group, a substituted or unsubstituted alkenyl group, or a substituted or unsubstituted aryl group;
M⁻ is at least one of hexafluorophosphate, tetrafluoroborate, difluoro(oxalato)borate, bis(oxalato)borate, bis(fluorosulfonyl)imide, or bis(trifluoromethane)sulfonimide; and when a substituent is comprised, the substituent is an alkyl group, a halogen group, or an alkoxy group.

4. The battery according to claim 3, wherein R is —C₁₋₃Alkyl, —C₁₋₃Alkylene-COO—C₁₋₃Alkyl, —C₂₋₄Alkenyl, or —C₆₋₈Aryl.

5. The battery according to claim 3, wherein the nitrogen-containing compound is at least one of the following two materials:

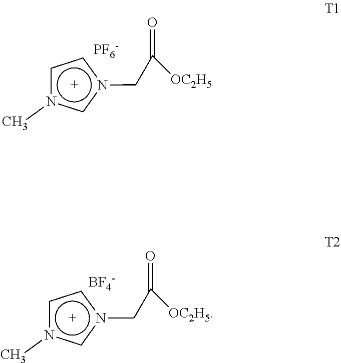

6. The battery according to claim 3, wherein a mass percentage of the nitrogen-containing compound in a total mass of the electrolyte solution is B wt %, wherein B wt %≤2 wt %.

7. The battery according to claim 2, wherein the non-aqueous organic solvent is selected from a carbonate ester and/or a carboxylic ester; and
the carbonate ester is selected from one or more of the following solvents: ethylene carbonate, propylene carbonate, dimethyl carbonate, diethyl carbonate, and ethyl methyl carbonate; and the carboxylic ester is selected from one or more of the following solvents: propyl acetate, n-butyl acetate, isobutyl acetate, n-amyl acetate, isoamyl acetate, ethyl propionate, n-propyl propionate, methyl butyrate, and ethyl n-butyrate.

8. The battery according to claim 2, wherein the non-aqueous organic solvent comprises a linear carbonate ester having a quantity of carbon atoms less than or equal to 5 and/or a linear carboxylic ester having a quantity of carbon atoms less than or equal to 5.

9. The battery according to claim 8, wherein a mass of the linear carbonate ester having a quantity of carbon atoms less than or equal to 5 and/or the linear carboxylic ester having a quantity of carbon atoms less than or equal to 5 accounts for 10 wt % to 70 wt % of a total mass of the electrolyte solution.

10. The battery according to claim 1, wherein the positive electrode plate comprises a positive electrode current collector and a positive electrode coating layer; the positive electrode coating layer comprises a first coating layer and a second coating layer, wherein the first coating layer is applied onto a surface of the positive electrode current collector, and the second coating layer is applied onto a surface of the first coating layer; the first coating layer comprises an inorganic filler, a first conductive agent and a first binder; the second coating layer comprises a positive electrode active material, a second conductive agent, and a second binder; and a thickness of the first coating layer is L, a thickness of the second coating layer is M, and L/M≤0.3.

11. The battery according to claim 10, wherein the thickness L of the first coating layer ranges from 2 μm to 10 μm and the thickness M of the second coating layer ranges from 30 μm to 80 μm.

12. The battery according to claim 10, wherein a content of the first binder in the first coating layer is greater than a content of the second binder in the second coating layer; and/or
mass percentages of components in the first coating layer are as follows: 40 wt % to 93 wt % of the inorganic filler, 2 wt % to 15 wt % of the first conductive agent, and 5 wt % to 58 wt % of the first binder; and/or
mass percentages of components in the second coating layer are as follows: 93 wt % to 99 wt % of the positive electrode active material, 0.5 wt % to 5 wt % of the second conductive agent, and 0.5 wt % to 2 wt % of the second binder.

13. The battery according to claim 10, wherein a median particle size Dv50 of the inorganic filler is less than a median particle size Dv50 of the positive electrode active material; and/or
a median particle size Dv50 of the inorganic filler ranges from 0.05 μm to 8 μm; and/or
a median particle size Dv50 of the positive electrode active material ranges from 10 μm to 20 μm.

14. The battery according to claim 2, wherein the negative electrode plate satisfies the following: a thickness of the negative electrode plate is less than 200 μm, and/or a single surface density of the negative electrode plate is less than or equal to 0.013 g/cm².

15. The battery according to claim 14, wherein a mass percentage of the nitrogen-containing compound in a total mass of the electrolyte solution is B wt %, wherein a ratio of B to a value of the thickness of the negative electrode plate is greater than or equal to 0.0001; and/or
a mass percentage of the nitrogen-containing compound in a total mass of the electrolyte solution is B wt %, wherein a ratio of B to a value of the single surface density of the negative electrode plate is greater than or equal to 6.

16. The battery according to claim 1, wherein a porosity of the negative electrode plate ranges from 20% to 55%; and/or
a press density of the negative electrode plate ranges from 1.2 g/cm³ to 1.9 g/cm³; and/or
an OI value of the negative electrode plate ranges from 4.3 to 34; and/or
a unit thickness capacity of the negative electrode plate ranges from 26.9 mAh/μm to 123 mAh/μm.

17. The battery according to claim 1, wherein a D/d range of the negative electrode plate is 1.04≤D/d≤1.1, wherein D is a thickness of the negative electrode plate obtained after rolling and left for 48 hours, and d is a thickness of the negative electrode plate obtained after rolling.

18. The battery according to claim 2, wherein the separator comprises a porous polyolefin separator base material, and a porosity of the porous polyolefin separator base material is greater than or equal to 35%.

19. The battery according to claim 18, wherein the porous polyolefin separator base material is selected from at least one of a porous polyethylene separator base material, a porous polypropylene separator base material, or a porous polyethylene-polypropylene composite separator base material; and/or
the separator further comprises a third coating layer, the third coating layer is provided on at least one functional surface of the porous polyolefin separator base material, and the third coating layer comprises at least one of inorganic particles or polymers; and/or
the inorganic particle is selected from at least one of aluminum oxide, silicon dioxide, boehmite, zinc oxide, magnesium oxide, zirconium dioxide, titanium oxide, barium oxide, calcium oxide, aluminum nitride, titanium nitride, silicon nitride, boron nitride, aluminum hydroxide, magnesium hydroxide, or barium sulfate; and/or
the polymer is selected from at least one of polyvinylidene fluoride, vinylidene fluoride-hexafluoropropylene copolymer, sodium carboxymethyl cellulose, polyacrylate, polyacrylonitrile, polyvinyl alcohol, styrene-butadiene rubber, polyurethane, ethylene-acrylic acid copolymer, polymethyl methacrylate, polyimide, aramid, polystyrene, or polyester.

20. The battery according to claim 3, wherein a mass percentage of the nitrogen-containing compound in a total mass of the electrolyte solution is B wt %, a ratio of B to a value of the porosity of the separator is greater than or equal to 0.02.
